(19) United States
(12) Patent Application Publication
(10) Pub. No.: US 2015/0082012 A1
(43) Pub. Date: Mar. 19, 2015

(54) SYSTEMS AND METHODS FOR PROVISIONING AN INFORMATION HANDLING SYSTEM FOR OPERATING SYSTEM STREAMING BASED ON INFORMATION HANDLING RESOURCE INVENTORY

(71) Applicant: Dell Products L.P., Round Rock, TX (US)

(72) Inventors: Carlton A. Andrews, Austin, TX (US); Gary Douglas Huber, Austin, TX (US); Yuan-Chang Lo, Austin, TX (US); Todd Swierk, Austin, TX (US)

(73) Assignee: Dell Products L.P., Round Rock, TX (US)

(21) Appl. No.: 14/028,814

(22) Filed: Sep. 17, 2013

(51) Int. Cl. G06F 9/44

(52) U.S. Cl. CPC G06F 9/4411; G06F 9/4416
USPC 713/2

(57) ABSTRACT

In accordance with embodiments of the present disclosure, a method for provisioning an information handling system for operating system streaming, the information handling system having one or more information handling resources, may be provided. The method may include receiving from the information handling system a boot request to boot a streaming operating system. The method may also include, responsive to determining that an operating system image associated with the information handling system is not available, instructing the information handling system to boot a service operating system for generating an inventory of the one or more information handling resources. The method may additionally include receiving the inventory from the information handling system. The method may further include generating a new operating system image including drivers for supporting the one or more information handling resources identified in the inventory.

### TECHNICAL FIELD

The present disclosure relates in general to information handling systems, and more particularly, to provisioning an information handling system for operating system streaming based on an information handling resource inventory of the information handling system.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Increasingly, information handling systems have utilized on-demand desktop streaming (ODDS) and other similar methods. ODDS is an approach used to provide a single, standard desktop image (e.g., an operating system and one or more application programs) to information handling systems from a network service. In ODDS, streaming applications execute on client systems using operating system streaming. Operating system streaming is a form of on-demand software distribution in which little or no portions of an application's code need to be installed on the client system. While the end user performs actions in the application, the necessary code and files are delivered over a network from a streaming application library as and when they are required. Operating system streaming is a related concept to application virtualization, where applications are ran directly from a virtual machine on a central server that is completely separate from the local system. By contrast, operating system streaming runs the program locally, but still involves the centralized storage of application code. Thus, in an ODDS implementation, individual information handling systems are often communicatively coupled to one or more provisioning servers. The one or more provisioning servers are generally configured to manage input/output (I/O) communications between the individual information handling systems and a storage array communicatively coupled to the one or more provisioning servers which hosts the streaming application library.

Because the shared image may be configured, delivered and managed centrally, costs associated with maintaining the network of information handling systems may be minimized, while providing greater security and flexibility. In an ODDS implementation, individual information handling systems are often communicatively coupled to one or more provisioning servers.

However, despite these advantages, one drawback of ODDS is that a streaming operating system and application image executable on one particular client may not be usable on another client, as the clients may differ in terms of the inventory of information handling resources (e.g., chipset, graphics hardware, network hardware, etc.) that each possesses. Accordingly, each client may require a different set of drivers to successfully execute a streaming operating system and application image. When a new model of information handling system is introduced into an enterprise, use of a streaming application may require assembling, often manually by an information technology professional or administrator of the enterprise, the correct set of drivers for the new model, which may be time consuming and costly, and delay initial usage of the information handling system.

### SUMMARY

In accordance with the teachings of the present disclosure, the disadvantages and problems associated with provisioning an information handling system for operating system streaming may be reduced or eliminated.

In accordance with embodiments of the present disclosure, a method for provisioning an information handling system for operating system streaming, the information handling system having one or more information handling resources, may be provided. The method may include receiving from the information handling system a boot request to boot a streaming operating system. The method may also include, responsive to determining that an operating system image associated with the information handling system is not available, instructing the information handling system to boot a service operating system for generating an inventory of the one or more information handling resources. The method may additionally include receiving the inventory from the information handling system. The method may further include generating a new operating system image including drivers for supporting the one or more information handling resources identified in the inventory.

In accordance with these and other embodiments of the present disclosure, an information handling system for provisioning a client information handling system for operating system streaming, the client information handling system having one or more information handling resources, may include a processor and non-transitory computer-readable media communicatively coupled to the processor. The computer-readable media may have stored thereon one or more instructions configured to, when executed by the processor: (i) receive from the client information handling system a boot request to boot a streaming operating system; (ii) responsive to determining that an operating system image associated with the client information handling system is not available, instruct the client information handling system to boot a service operating system for generating an inventory of the one or more information handling resources; (iii) receive the inventory from the client information handling system; and (iv) generate a new operating system image including drivers for supporting the one or more information handling resources identified in the inventory.

In accordance with these and other embodiments of the present, an article of manufacture may include a non-transitory computer-readable medium and computer-executable instructions carried on the computer readable medium. The instructions may be readable by a processor, the instructions, when read and executed, for causing the processor to: (i) receive from a client information handling system a boot request to boot a streaming operating system; (ii) responsive to determining that an operating system image associated with the client information handling system is not available, instruct the client information handling system to boot a service operating system for generating an inventory of one or more information handling resources; (iii) receive the inventory from the client information handling system; and (iv) generate a new operating system image including drivers for supporting the one or more information handling resources identified in the inventory.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example system for enabling operating system streaming to one or more client information handling systems, in accordance with the teachings of the present disclosure; and

FIG. 2 illustrates a flow chart of an example method for provisioning an information handling system for operating system streaming, in accordance with embodiments of the present disclosure.

### DETAILED DESCRIPTION

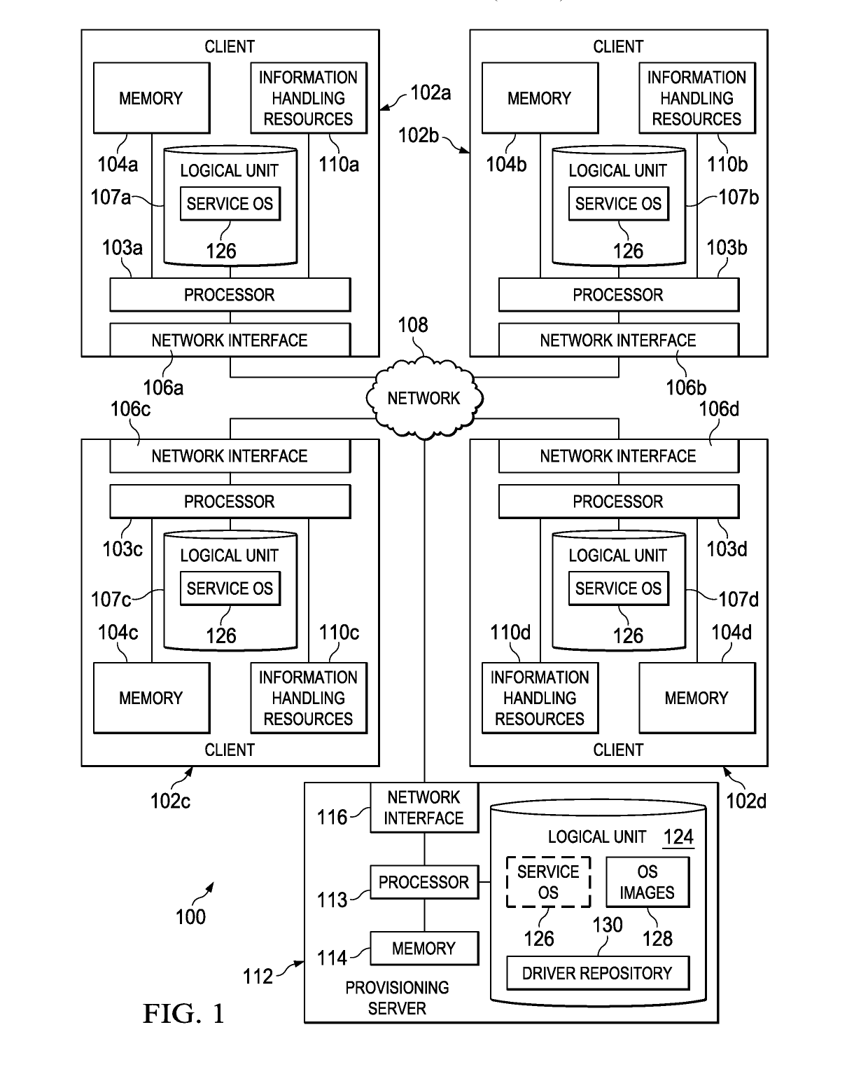

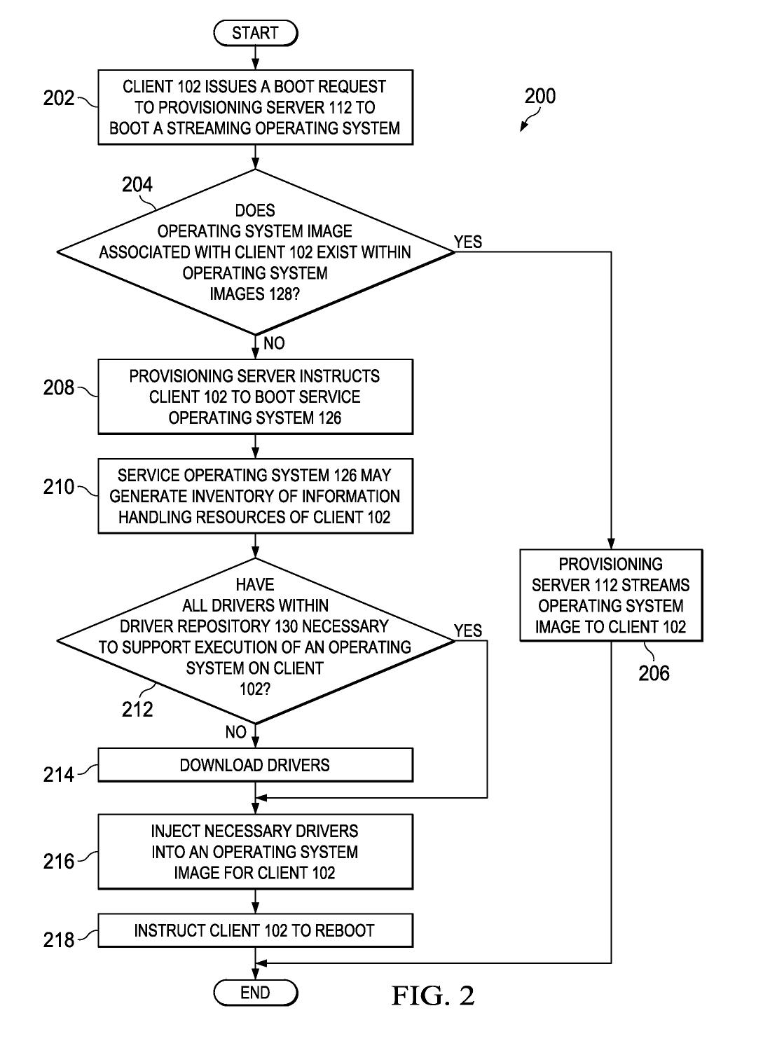

Preferred embodiments and their advantages are best understood by reference to FIGS. 1 and 2, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a tablet, a PDA, a consumer electronic device, a network storage device, or any other suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems, buses, memories, I/O devices and/or interfaces, storage resources, network interfaces, motherboards, and/or any other components and/or elements of an information handling system.

An information handling system may include or may be coupled via a network to one or more arrays of storage resources. The array of storage resources may include a plurality of storage resources, and may be operable to perform one or more input and/or output storage operations, and/or may be structured to provide redundancy. In operation, one or more storage resources disposed in an array of storage resources may appear to an operating system as a single logical storage unit or “logical unit.”

In certain embodiments, an array of storage resources may be implemented as a Redundant Array of Independent Disks (also referred to as a Redundant Array of Inexpensive Disks or a RAID). RAID implementations may employ a number of techniques to provide for redundancy, including striping, mirroring, and/or parity checking. As known in the art, RAIDs may be implemented according to numerous RAID standards, including without limitation, RAID 0, RAID 1, RAID 0+1, RAID 3, RAID 4, RAID 5, RAID 6, RAID 01, RAID 03, RAID 10, RAID 30, RAID 50, RAID 51, RAID 53, RAID 60, RAID 100, etc.

FIG. 1 illustrates a block diagram of an example system 100 for enabling operating system streaming to one or more client information handling systems, in accordance with the teachings of the present disclosure. As depicted, system 100 may include one or more clients 102, a network 108, and one or more provisioning servers 112.

Each client 102 may comprise an information handling system and may generally be configured to communicate via network 108 with one or more of provisioning servers 112. In certain embodiments, one or more of clients 102 may be a server. In another embodiment, one or more of clients 102 may be a personal computer (e.g., a desktop computer or a portable computer). As depicted in FIG. 1, each client 102 may include a processor 103, a memory 104 communicatively coupled to processor 103, a network interface 106 communicatively coupled to processor 103, and one or more information handling resources 110. Although system 100 is depicted as having four clients 102, system 100 may include any suitable number of clients 102.

Each processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104, logical unit 124 and/or another component of system 100.

Each memory 104 may be communicatively coupled to its associated processor 103 and may include any system, device, or apparatus configured to retain program instructions and/or data for a period of time (e.g., computer-readable media). Each memory 104 may include random access memory (RAM), electrically erasable programmable read-only memory (EEPROM), a PCMCIA card, flash memory, magnetic storage, opto-magnetic storage, or any suitable selection and/or array of volatile or non-volatile memory that retains data after power to its associated client 102 is turned off.

Each network interface 106 may include any suitable system, apparatus, or device operable to serve as an interface between its associated client 102 and network 108. Each network interface 106 may enable its associated client 102 to communicate over network 108 using any suitable transmission protocol and/or standard, including without limitation all transmission protocols and/or standards enumerated below with respect to the discussion of network 108.

A logical unit 107 may include any suitable number and/or combination of storage resources configured to store data. Such storage resources may include hard disk drives, magnetic tape libraries, optical disk drives, magneto-optical disk drives, solid state storage drives, compact disk drives, compact disk arrays, disk array controllers, and/or any other systems, apparatuses or devices configured to store data. In certain embodiments, logical unit 107 may include one or more storage enclosures configured to hold and/or power one or more of such storage resources. In the embodiments represented by FIG. 1, logical unit 107 may reside within an associated client 102. However, in other embodiments, logical unit 107 may reside external to its associated client 102 (e.g., may be coupled to client 102 via network 108).

As shown in FIG. 1, a logical unit 107 may have stored thereon a service operating system 126. Service operating system 126 may comprise a program of instructions which a client 102 may execute such that service operating system 126 generates an inventory of the information handling resources of such client 102, including information regarding processor 103, memory 104, network interface 106, logical unit 107, and/or one or more other information handling resources 110 of such client 102. Service operating system 126 may generate such inventory in any suitable manner, including without limitation querying a basic input/output system (BIOS) of client 102 for such information. In the embodiments represented by FIG. 1, one or more clients 102 may locally store (e.g., in a BIOS, flash memory, or other computer-readable medium of such clients 102) a service operating system 126, and execute service operating system 126 by loading it from the local storage location into memory 104 for execution. In other embodiments, service operating system 126 may be stored at provisioning server 112, and thus may use operating system streaming to execute at a particular client 102. In some or all of such embodiments, service operating system 126 may be a generally “hardware-agnostic” operating system, such that service operating system 126 may execute on many clients 102 regardless of the information handling resource configuration of such clients 102. In some embodiments, service operating system 126 may be a limited-purpose operating system configured to carry out the limited functionality of generating the information handling resource inventory of a client 102, and therefore may be significantly less robust in terms of size and functionality as operating system images 128 and/or other executable programs.

For each client 102, one or more information handling resources 110 may be communicatively coupled to an associated processor 103 and may include one or more processors, service processors, basic input/output systems, buses, memories, I/O devices and/or interfaces, storage resources, network interfaces, motherboards, and/or any other components and/or elements suitable for use in an information handling system.

Network 108 may be a network and/or fabric configured to couple clients 102 and provisioning server 112. As an example, in certain embodiments, network 108 in connection with provisioning server 112 may allow one or more of clients 102 to couple to logical unit 124 such that portions of logical unit 124 assigned to a particular client 102 appear to such particular client 102 as locally attached storage resources. As another example, network 108 in connection with provisioning server 112 may allow one or more of clients 102 to couple to logical unit 124 such that one or more clients 102 may receive and execute streaming applications and streaming data stored on logical unit 124.

In the same or alternative embodiments, network 108 may include a communication infrastructure, which provides physical connections, and a management layer, which organizes the physical connections, clients 102, and provisioning server 112. In the same or alternative embodiments, network 108 may allow block I/O services and/or file access services to logical unit 124. Network 108 may be implemented as, or may be a part of, a personal area network (PAN), local area network (LAN), a metropolitan area network (MAN), a wide area network (WAN), a wireless local area network (WLAN), a virtual private network (VPN), an intranet, the Internet, or any other appropriate architecture or system that facilitates the communication of signals, data, and/or messages (generally referred to as data). Network 108 may transmit data using any storage and/or communication protocol, including without limitation, Fibre Channel, Frame Relay, Asynchronous Transfer Mode (ATM), Internet protocol (IP), other packet-based protocol, small computer system interface (SCSI), advanced technology attachment (ATA), serial ATA (SATA), advanced technology attachment packet interface (ATAPI), serial storage architecture (SSA), integrated drive electronics (IDE), and/or any combination thereof. Network 108 and its various components may be implemented using hardware, firmware, software, or any combination thereof.

Provisioning server 112 may comprise an information handling system and may generally be operable to communicate via network 108 with one or more of clients 102. In operation, provisioning server 112 may provision one or more streaming applications, operating systems, and/or data (e.g. stored on logical unit 124), as described in greater detail elsewhere in this disclosure. As depicted in FIG. 1, each provisioning server 112 may include a processor 113, a memory 114 communicatively coupled to processor 113, a network interface 116 communicatively coupled to processor 113, and a logical unit 124. Each processor 113, memory 114, and network interface 116 may be similar or identical in structure and/or functionality to processor 103, memory 104, and network interface 106, respectively. Although system 100 is depicted as having one provisioning server 112, system 100 may include any suitable number of provisioning servers 112.

Logical unit 124 may include any suitable number and/or combination of storage resources configured to store data. Such storage resources may include hard disk drives, magnetic tape libraries, optical disk drives, magneto-optical disk drives, solid state storage drives, compact disk drives, compact disk arrays, disk array controllers, and/or any other systems, apparatuses or devices configured to store data. In certain embodiments, logical unit 124 may include one or more storage enclosures configured to hold and/or power one or more of such storage resources. In the embodiments represented by FIG. 1, logical unit 124 may reside within provisioning server 112. However, in other embodiments, logical unit 124 may reside external to provisioning server 112 (e.g., may be coupled to provisioning server 112 via network 108).

As shown in FIG. 1, logical unit 124 may store one or more operating system images 128 and a driver repository 130. Also, as noted above, in some embodiments logical unit may store service operating system 126.

Operating system images 128 may comprise one or more images of operating systems executable via streaming by one or more clients 102. In some embodiments, operating system images 128 may be generated in whole or part based on inventory information for one or more clients 102 generated by service operating system 126, such that a particular operating system image 128 may include drivers or other components enabling execution of the particular operating system image 128 on one or more clients 102.

Driver repository 130 may comprise a library of one or more device drivers. As is known in the art, a device driver may be a program of instructions that interfaces between an information handling resource and an operating system and controls the functionality of the information handling resource.

FIG. 2 illustrates a flow chart of an example method 200 for provisioning a client information handling system (e.g., a client 102) for operating system streaming, in accordance with embodiments of the present disclosure. According to certain embodiments, method 200 may begin at step 202. As noted above, teachings of the present disclosure may be implemented in a variety of configurations of system 100. As such, the preferred initialization point for method 200 and the order of the steps comprising method 200 may depend on the implementation chosen.

At step 202, a client 102 may issue a boot request to provisioning server 112 to boot a streaming operating system stored within operating system images 128. At step 204, responsive to the boot request, provisioning server 112 may determine if an operating system image associated with client 102 exists within operating system images 128. If an operating system image associated with client 102 exists, method 200 may proceed to step 206. Otherwise method 200 may proceed to step 208.

At step 206, in response to a determination that an operating system image associated with client 102 exists within operating system images 128, provisioning server 112 may stream the operating system image to client 102, such that client 102 boots its associated operating system. After completion of step 206, method 200 may end.

At step 208, in response to a determination that an operating system image associated with client 102 does not exist within operating system images 128, provisioning server 112 may instruct client 102 to boot service operating system 126 either from a computer-readable medium local to client 102 (e.g., via a well-known bootstrap technique) or remotely from provisioning server 112 (e.g., via Windows Pre-execution Environment, or similar manner).

At step 210, after booting, service operating system 126 may generate an inventory of information handling resources of client 102 (e.g., by interfacing with or querying a BIOS of client 102), and communicate such inventory to provisioning server 112.

At step 212, based on the received inventory, provisioning server 112 may determine if it has all drivers within driver repository 130 necessary to support execution of an operating system on client 102. If provisioning server 112 has all necessary drivers, method 200 may proceed to step 216. Otherwise, method 200 may proceed to step 214.

At step 214, in response to a determination that provisioning server 112 does not have all required drivers, provisioning server 112 may download such drivers (e.g., from an information handling system coupled to provisioning server 112 via network 108).

At step 216, provisioning server 112 may inject the necessary drivers into an operating system image for client 102, and store the operating system image in operating system images 128. Such operating system image may then have all necessary drivers to successfully execute the operating system in a subsequent boot of client 102.

At step 218, provisioning server 112 may instruct client 102 to reboot. As a result, method 200 may execute again from step 202, but in such second execution of method 200, will proceed to step 206, and boot from its associated operating system streamed from provisioning server 112. After completion of step 218, method 200 may end.

Although FIG. 2 discloses a particular number of steps to be taken with respect to method 200, method 200 may be executed with greater or fewer steps than those depicted in FIG. 2. In addition, although FIG. 2 discloses a certain order of steps to be taken with respect to method 200, the steps comprising method 200 may be completed in any suitable order.

Method 200 may be implemented using information handling system 100, components thereof, and/or any other system operable to implement method 200. In certain embodiments, method 200 may be implemented partially or fully in software and/or firmware embodied in computer-readable media.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. A method for provisioning an information handling system for operating system streaming, the information handling system having one or more information handling resources, the method comprising:
receiving from the information handling system a boot request to boot a streaming operating system;
responsive to determining that an operating system image associated with the information handling system is not available, instructing the information handling system to boot a service operating system for generating an inventory of the one or more information handling resources;
receiving the inventory from the information handling system; and
generating a new operating system image including drivers for supporting the one or more information handling resources identified in the inventory.

2. The method of claim 1, further comprising instructing the information handling system to boot the new operating system image.

3. The method of claim 2, further comprising streaming the new operating system image to the information handling system responsive to a boot request from the information handling system.

4. The method of claim 1, further comprising downloading one or more of the drivers responsive to receiving the inventory.

5. The method of claim 1, wherein the information handling system boots the service operating system locally.

6. The method of claim 1, further comprising streaming the service operating system to the information handling system.

7. The method of claim 1, wherein the service operating system generates the inventory by retrieving such information from a basic input/output system of the information handling system.

8. An information handling system for provisioning a client information handling system for operating system streaming, the client information handling system having one or more information handling resources, the information handling system comprising:
a processor; and
non-transitory computer-readable media communicatively coupled to the processor and having stored thereon one or more instructions configured to, when executed by the processor:
receive from the client information handling system a boot request to boot a streaming operating system;
responsive to determining that an operating system image associated with the client information handling system is not available, instruct the client information handling system to boot a service operating system for generating an inventory of the one or more information handling resources;
receive the inventory from the client information handling system; and
generate a new operating system image including drivers for supporting the one or more information handling resources identified in the inventory.

9. The information handling system of claim 8, the one or more instructions further configured to instruct the client information handling system to boot the new operating system image.

10. The information handling system of claim 9, the one or more instructions further configured to stream the new operating system image to the information handling system responsive to a boot request from the information handling system.

11. The information handling system of claim 8, the one or more instructions further configured to download one or more of the drivers responsive to receiving the inventory.

12. The information handling system of claim 8, wherein the information handling system boots the service operating system locally.

13. The information handling system of claim 8, the one or more instructions further configured to stream the service operating system to the information handling system.

14. The information handling system of claim 8, wherein the service operating system generates the inventory by retrieving such information from a basic input/output system of the information handling system.

15. An article of manufacture comprising:
a non-transitory computer-readable medium; and
computer-executable instructions carried on the computer readable medium, the instructions readable by a processor, the instructions, when read and executed, for causing the processor to:
receive from a client information handling system a boot request to boot a streaming operating system;
responsive to determining that an operating system image associated with the client information handling system is not available, instruct the client information handling system to boot a service operating system for generating an inventory of one or more information handling resources;
receive the inventory from the client information handling system; and
generate a new operating system image including drivers for supporting the one or more information handling resources identified in the inventory.

16. The article of claim 15, the instructions for further causing the processor to instruct the client information handling system to boot the new operating system image.

17. The article of claim 16, the instructions for further causing the processor to stream the new operating system image to the information handling system responsive to a boot request from the client information handling system.

18. The article of claim 15, the instructions for further causing the processor to download one or more of the drivers responsive to receiving the inventory.

19. The article of claim 15, wherein the client information handling system boots the service operating system locally.

20. The article of claim 15, the instructions for further causing the processor to stream the service operating system to the client information handling system.

21. The article of claim 15, wherein the service operating system generates the inventory by retrieving such information from a basic input/output system of the client information handling system.
